(19) United States
(12) Patent Application Publication
(10) Pub. No.: US 2026/0222728 A1
(43) Pub. Date: Jul. 30, 2026

(54) ELECTRONIC DEVICE AND OPERATION METHOD THEREOF

(71) Applicant: Samsung Electronics Co., Ltd., Suwon-si (KR)

(72) Inventors: Mooyeol KIM, Suwon-si (KR); Seoweon KYUNG, Suwon-si (KR); Sunjung KWAK, Suwon-si (KR); Kitae KIM, Suwon-si (KR); Choonho KIM, Suwon-si (KR); Taebin KIM, Suwon-si (KR)

(21) Appl. No.: 19/578,256

(22) Filed: Mar. 25, 2026

Related U.S. Application Data
(63) Continuation of application No. PCT/KR2024/011129, filed on Jul. 30, 2024.

(30) Foreign Application Priority Data
Sep. 26, 2023 (KR) 10-2023-0129815
Oct. 25, 2023 (KR) 10-2023-0143886

(51) Int. Cl. H04R 1/10; H04W 4/02; H04W 76/10

(52) U.S. Cl. CPC H04R 1/1083; H04W 4/023; H04W 76/10

(57) ABSTRACT

An electronic device may be configured to: make a call connection to a first external device; identify a first token including information related to the call connection to the first external device; transmit the first token using a communication circuit; receive a second token; based on the second token, identify information related to a call connection to an external device which transmitted the second token; based on the information related to the call connection, included in the second token, corresponding to the information related to the call connection to the first external device or information of the electronic device, identify that the external device having transmitted the second token is the first external device; identify distance information and/or angle information between the first external device and the electronic device using the communication circuit; and based on the distance information or the angle information, control an anti-howler for the call connection.

### CROSS-REFERENCE TO RELATED APPLICATIONS

This application is a continuation of International Application No. PCT/KR2024/011129 designating the United States, filed on Jul. 30, 2024, in the Korean Ministry of Intellectual Property Receiving Office and claiming priority to Korean Patent Application Nos. 10-2023-0129815, filed on Sep. 26, 2023, and 10-2023-0143886, filed on Oct. 25, 2023, in the Korean Ministry of Intellectual Property, the disclosures of each of which are incorporated by reference herein in their entireties.

### BACKGROUND

### Field

The disclosure relates to an electronic device and an operating method thereof.

### Description of Related Art

An anti-howler is a solution for reducing howling occurring during a call connection between adjacent user terminals. During a call connection between physically adjacent user terminals, a speaker output of a first terminal may be introduced into a microphone of a second terminal, and the introduced signal may be amplified and output through a speaker of the second terminal. Since this phenomenon is continuously repeated, howling occurs, and an anti-howler is a solution for suppressing this.

Ultra wide band (UWB) is a wireless communication technology transmitting a large amount of information with low power over a very wide band compared to existing spectrums. The UWB is a wireless communication technology using a frequency band having a gigahertz (GHz) width and capable of transmitting at a speed of 100 to 500 megabytes (MB) per second, and may completely transmit large-capacity video without shaking or loss, and the transmission distance is 1 kilometer (km), which is 10 times longer than 100 meters (m) of Bluetooth, so that a perfect home networking system may be implemented and wires of all digital home appliances may be eliminated. An electronic device may obtain distance and angle information to a counterpart terminal through a plurality of antennas using UWB.

Microphone beamforming is a technology that, when a plurality of microphones are used, may focus on or filter voice in a specific direction using a delay and directivity between the microphones.

The information may be provided as a related art for the purpose of helping understanding of the disclosure. No assertion or determination is made as to whether any of the foregoing is applicable as background art in relation to the disclosure.

### SUMMARY

According to an example embodiment, an electronic device may include: memory storing instructions, a communication circuit supporting an ultra wide band (UWB) scheme, at least one microphone, at least one speaker, and at least one processor, comprising processing circuitry. The instructions may, when executed by at least one processor, individually or collectively, cause the electronic device to: perform a call connection to a first external device; identify a first token including information related to the call connection to the first external device; transmit the first token and receive a second token, using the communication circuit; identify information related to a call connection of an external device transmitting the second token, based on the second token; based on the information related to the call connection included in the second token corresponding to the information related to the call connection to the first external device, or information of the electronic device, identify that the external device transmitting the second token is the first external device; identify distance information and/or angle information between the first external device and the electronic device, using the communication circuit; and control an anti-howler related to the call connection, based on the distance information and/or the angle information.

According to an example embodiment, a method of operating an electronic device may include: performing a call connection to a first external device; identifying a first token including information related to the call connection to the first external device; transmitting the first token and receiving a second token, using a communication circuit supporting an ultra wide band (UWB) scheme; identifying information related to a call connection of an external device transmitting the second token, based on the second token; based on the information related to the call connection included in the second token corresponding to the information related to the call connection to the first external device, or information of the electronic device, identifying that the external device transmitting the second token is the first external device; identifying distance information and/or angle information between the first external device and the electronic device, using the communication circuit; and controlling an anti-howler related to the call connection, based on the distance information and/or the angle information.

According to an example embodiment, in a non-transitory computer-readable recording medium storing instructions which, when executed by at least one processor, comprising processing circuitry, of an electronic device individually or collectively, cause the electronic device to perform at least one operation comprising: performing a call connection to a first external device; identifying a first token including information related to the call connection to the first external device; transmitting the first token and receiving a second token, using a communication circuit supporting an ultra wide band (UWB) scheme; identifying information related to a call connection of an external device transmitting the second token, based on the second token; based on the information related to the call connection included in the second token corresponding to the information related to the call connection to the first external device, or information of the electronic device, identifying that the external device transmitting the second token is the first external device; identifying distance information and/or angle information between the first external device and the electronic device, using the communication circuit; and controlling an anti-howler related to the call connection, based on the distance information and/or the angle information.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to an embodiment.

FIG. 2A is a signal flow diagram illustrating an example distance measurement process based on UWB communication, according to an embodiment.

FIG. 2B is a signal flow diagram illustrating an example distance measurement process based on UWB communication, according to an embodiment.

FIG. 2C is a diagram illustrating an example direction measurement process based on reception of a UWB signal, according to an embodiment.

FIG. 3 is a block diagram illustrating example configurations of a first electronic device and a second electronic device, according to an embodiment.

FIG. 4 is a diagram illustrating transmission/reception of a communication signal for each antenna of a second communication circuit, according to an embodiment.

FIG. 5A is a diagram illustrating an example of howling occurrence, according to an embodiment.

FIG. 5B is a block diagram illustrating an example configuration of an electronic device, according to an embodiment.

FIG. 6 is a block diagram illustrating an example configuration of an electronic device, according to an embodiment.

FIG. 7 is a flowchart illustrating an example method of operating an electronic device, according to an embodiment.

FIG. 8 is a flowchart illustrating an example method of operating an electronic device according to an embodiment;

FIG. 9 is a flowchart illustrating an example method of operating an electronic device according to an embodiment.

FIG. 10A is a diagram illustrating an example operation of an electronic device, according to an embodiment.

FIG. 10B is a diagram illustrating an example operation of an electronic device, according to an embodiment.

FIG. 11 is a flowchart illustrating an example method of operating an electronic device, according to an embodiment.

### DETAILED DESCRIPTION

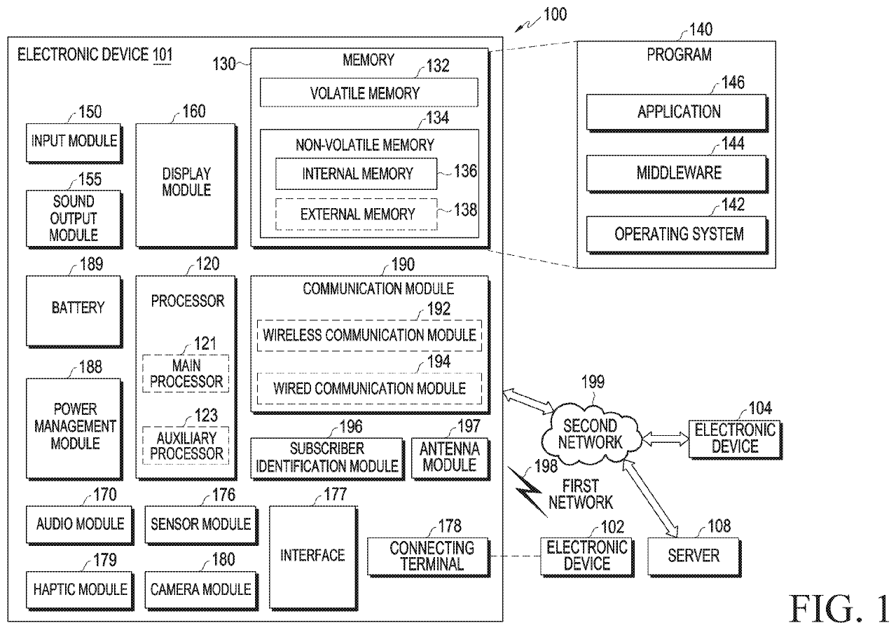

FIG. 1 is a block diagram illustrating an example electronic device 101 in a network environment 100 according to an embodiment.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wiredly) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

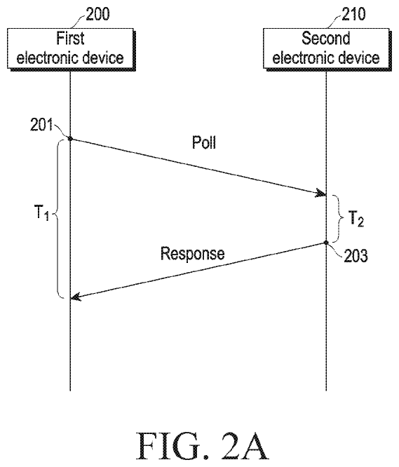

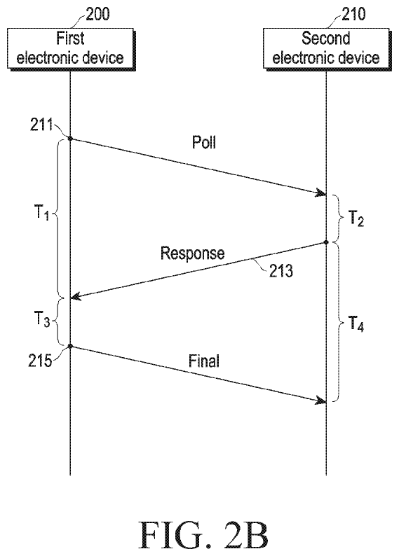

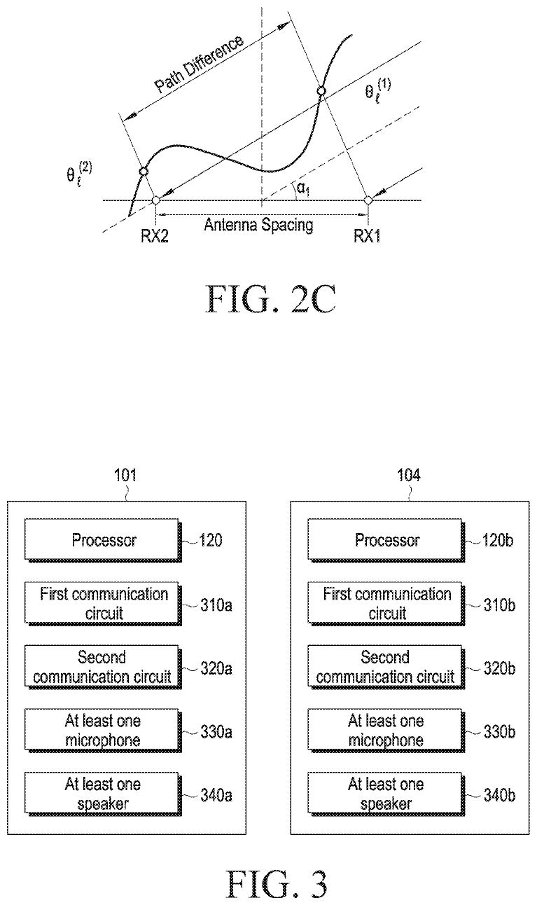

FIG. 2A is a signal flow diagram illustrating an example distance measurement process based on ultra wide band (UWB) communication, according to an embodiment. FIG. 2B is a flowchart illustrating an example distance measurement process based on UWB communication, according to an embodiment.

A first electronic device 200 and a second electronic device 210 illustrated in FIGS. 2A and 2B are electronic devices supporting UWB communication, and there is no limitation on the types thereof. For example, the first electronic device 200 and/or the second electronic device 210 may be the same type of electronic device as the electronic device 101 (or the electronic device 104) of FIG. 1, and the description of the electronic device 101 (or the electronic device 104) of FIG. 1 may be applied to the first electronic device 200 and/or the second electronic device 210 within a necessary range. For example, the first electronic device 200 of FIG. 2 may be the electronic device 101 of FIG. 1. For example, the second electronic device 210 of FIG. 2 may be the electronic device 104 of FIG. 1. Hereinafter, with respect to the description of an operation of the first electronic device 200 and the second electronic device 210 using UWB, those skilled in the art may understand that the first electronic device 200 may perform an operation described as an operation of the second electronic device 210, and the second electronic device 200 may also perform an operation described as an operation of the first electronic device 200.

Referring to FIG. 2A, according to an embodiment, the first electronic device 200 (e.g., a processor (e.g., 120 of FIG. 1) of the first electronic device 200 and/or a communication module (e.g., 190 of FIG. 1) of the first electronic device 200) may identify a distance to the second electronic device 210 based on a single-sided two-way ranging (SS-TWR) scheme. The first electronic device 200 may transmit a poll message (e.g., ranging poll) in operation 201. For example, the communication module (e.g., 190 of FIG. 1) of the first electronic device 200 may include a UWB communication module, and the UWB communication module may transmit the poll message. The second electronic device 210 (e.g., a processor (e.g., 120 of FIG. 1) of the second electronic device 210 and/or a communication module (e.g., 190 of FIG. 1) of the second electronic device 210) may receive the poll message, and in response thereto, may transmit a response message (e.g., ranging response) in operation 203. For example, the communication module (e.g., 190 of FIG. 1) of the second electronic device 210 may include a UWB communication module, and the UWB communication module may transmit the response message. The second electronic device 210 may consume a second time T2 for receiving the poll message and transmitting the response message corresponding to the poll message, and the second time may be referred to as, e.g., a process time. The second electronic device 210 may transmit the process time, e.g., information of the second time T2, to the first electronic device 200 by including it in the response message.

The second electronic device 200 according to an embodiment may identify a distance between the first electronic device 200 and the second electronic device 210, based on a time of transmitting the poll message, a time of receiving the response message, and the process time (e.g., the second time T2) included in the response message. For example, when a difference between the time of transmitting the poll message and the time of receiving the response message is a first time T1, the first electronic device 200 may identify (T1−T2 )*c/2 (c is a speed of light) as the distance between the first electronic device 200 and the second electronic device 210.

Referring to FIG. 2B, according to an embodiment, the first electronic device 200 (e.g., a processor (e.g., 120 of FIG. 1) of the first electronic device 200 and/or a communication module (e.g., 190 of FIG. 1) of the first electronic device 200) may identify a distance to the second electronic device 210 based on a double-sided two-way ranging (DS-TWR) scheme. The first electronic device 200 may transmit a poll message in operation 211. For example, the communication module (e.g., 190 of FIG. 1) of the first electronic device 200 may include a UWB communication module, and the UWB communication module may transmit the poll message. The second electronic device 210 (e.g., a processor (e.g., 120 of FIG. 1) of the second electronic device 210 and/or a communication module (e.g., 190 of FIG. 1) of the second electronic device 210) may receive the poll message, and in response thereto, may transmit a response message in operation 213. For example, the communication module (e.g., 190 of FIG. 1) of the second electronic device 210 may include a UWB communication module, and the UWB communication module may transmit the response message. The second electronic device 210 may consume a process time of a second time T2 for receiving the poll message and transmitting the response message corresponding to the poll message. The second electronic device 210 may transmit the process time, e.g., information of the second time T2, to the first electronic device 200 by including it in the response message.

According to an embodiment, the first electronic device 200 may transmit a final message (e.g., ranging final) based on the reception of the response message in operation 215. For example, the first electronic device 200 may consume a process time of a third time T3 for receiving the response message and transmitting the final message corresponding to the response message. The first electronic device 200 may transmit the process time, e.g., information of the third time T3, to the second electronic device 210 by including it in the final message.

The first electronic device 200 according to an embodiment may identify a distance between the first electronic device 200 and the second electronic device 210, based on a time of transmitting the poll message, a time of receiving the response message, and the process time (e.g., the second time T2) included in the response message. The second electronic device 210 according to an embodiment may identify a distance between the first electronic device 200 and the second electronic device 210, based on a time of transmitting the response message, a time of receiving the final message, and the process time (e.g., the third time T3) included in the final message. For example, when a difference between the time of transmitting the response message and the time of receiving the final message is a fourth time T4, the second electronic device 210 may identify (T4−T3)*c/2 (c is a speed of light) as the distance between the first electronic device 200 and the second electronic device 210.

FIG. 2C is a diagram illustrating an example direction measurement process based on reception of a UWB signal, according to an embodiment.

Hereinafter, a direction measurement process based on reception of a UWB signal is described from a viewpoint of the first electronic device 200 with reference to FIG. 2C, but those skilled in the art will understand that such a description may also be applied to a direction measurement process based on reception of a UWB signal from a viewpoint of the second electronic device 210. A direction may be understood as an angle.

Referring to FIG. 2C, according to an embodiment, the first electronic device 200 (e.g., a processor (e.g., 120 of FIG. 1) of the first electronic device 200 and/or a communication module (e.g., 190 of FIG. 1) of the first electronic device 200) may identify a direction of the second electronic device 210 with respect to the first electronic device 200, based on an angle of arrival (AOA) scheme. For example, the communication module (e.g., 190 of FIG. 1) (e.g., a UWB communication module) of the first electronic device 200 may support two receiving antennas RX1 and RX2. The two receiving antennas RX1 and RX2 may be disposed to have an antenna spacing. It is assumed that the second electronic device 210 is located in a direction of an α1 angle with respect to the first electronic device 200. In this case, due to the antenna spacing, a difference in a signal reception time at each of both receiving antennas RX1 and RX2, and a phase difference of signals occur. For example, a phase of a signal received at a first receiving antenna RX1 may be θl(1), and a phase of a signal received at a second receiving antenna RX2 may be θl(2). The first electronic device 200 may identify an angle α1 where the second electronic device 210 is located, based on a phase difference of phases measured at each of both receiving antennas RX1 and RX2 (or a difference in a reception time measured at each of both receiving antennas) and the antenna spacing.

According to an embodiment, the first electronic device 200 may identify a first angle, which is a direction in which the second electronic device 210 is located with respect to the first electronic device 200, based on a measurement result at the two receiving antennas RX1 and RX2. According to an embodiment, the first electronic device 200 may include three or more receiving antennas. The first electronic device 200 may identify a first angle, which is a direction in which the second electronic device 210 is located with respect to the first electronic device 200, based on a measurement result at two receiving antennas of a first combination, and identify a second angle, which is a direction in which the second electronic device 210 is located with respect to the first electronic device 200, based on a measurement result at two receiving antennas of a second combination.

As described above, the first electronic device 200 may identify a distance to the second electronic device 210 and/or a direction (or angle) of the second electronic device 210. Further, as described above, the second electronic device 210 may identify a distance to the first electronic device 200 and/or a direction (or angle) of the first electronic device 200, and overlapping descriptions is omitted.

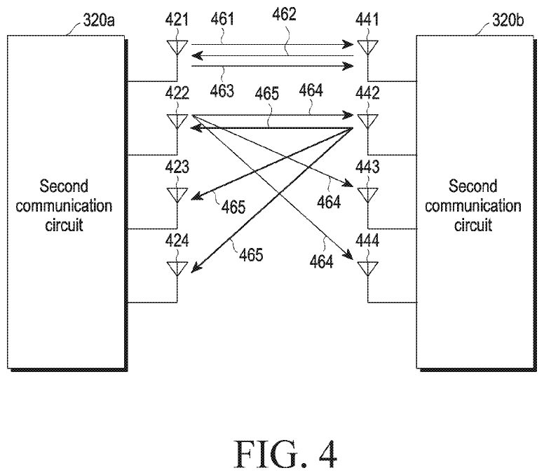

FIG. 3 is a block diagram illustrating example configurations of an electronic device 101 and an external electronic device 104, according to an embodiment. FIG. 3 is described with reference to FIG. 4. FIG. 4 is a diagram illustrating example transmission/reception of a communication signal for each antenna of a second communication circuit 320a, 320b, according to an embodiment.

The electronic device 101 of FIG. 3 may be the first electronic device 200 of FIG. 2. The external electronic device 104 of FIG. 3 may be the second electronic device 210 of FIG. 2.

Referring to FIG. 3, an electronic device 101 according to an embodiment may include a processor (e.g., including processing circuitry) 120, a first communication circuit 310a, a second communication circuit 320a, at least one microphone 330a, and at least one speaker 340a. For example, the first communication circuit 310a and the second communication circuit 320a may be included in the communication module 190 of FIG. 1. For example, the first communication circuit 310a may be a communication circuit for a call connection to an external device (e.g., the external electronic device 104). For example, the second communication circuit 320a may be a communication circuit supporting a UWB communication scheme. There is no limitation on a number of the at least one microphone 330a and a location where the at least one microphone 330a is disposed. There is no limitation on a number of the at least one speaker 340a and a location where the at least one speaker 340a is disposed. An external electronic device 104 according to an embodiment may include a processor (e.g., including processing circuitry) 120b, a first communication circuit 310b, a second communication circuit 320b, at least one microphone 330b, and at least one speaker 340b. For example, the first communication circuit 310b and the second communication circuit 320b may be included in a communication module of the external electronic device 104 corresponding to the communication module 190 of FIG. 1. For example, the first communication circuit 310b may be a communication circuit for a call connection to an external device (e.g., the electronic device 101). For example, the second communication circuit 320b may be a communication circuit supporting a UWB communication scheme. There is no limitation on a number of the at least one microphone 330b and a location where the at least one microphone 330b is disposed. There is no limitation on a number of the at least one speaker 340b and a location where the at least one speaker 340b is disposed. It will also be understood that the description above of the processor 120 applies equally to the processors 120a and 120b and thus a detailed description may not be repeated here.

According to an embodiment, a sensor module (e.g., 176 of FIG. 1) of the electronic device 101 may sense at least one data for identifying an orientation of the electronic device 101. The processor 120 may identify the orientation of the electronic device 101, based on the at least one data from the sensor module (e.g., 176 of FIG. 1). A sensor module (e.g., a sensor module corresponding to 176 of FIG. 1) of the external electronic device 104 may sense at least one data for identifying an orientation of the external electronic device 104. The processor 120b may identify the orientation of the external electronic device 104, based on the at least one data from the sensor module (e.g., a sensor module corresponding to 176 of FIG. 1). The sensor module (e.g., 176 of FIG. 1) of the electronic device 101 and/or the sensor module (e.g., a sensor module corresponding to 176 of FIG. 1) of the external electronic device 104 may include, e.g., an acceleration sensor, a gyro sensor, and/or a geomagnetic sensor, but there is no limitation on a type of the sensor. The orientation of the electronic device 101 and/or the orientation of the external electronic device 104 may be represented by, e.g., at least one angle, but there is no limitation on a format of the expression.

According to an embodiment, the electronic device 101 may receive a communication signal including information on the orientation of the external electronic device 104 through a communication module (e.g., 190 of FIG. 1). The processor 120b of the external electronic device 104 may identify the orientation of the external electronic device 104, and may transmit a communication signal including information on the orientation through a communication module (e.g., a communication module corresponding to 190 of FIG. 1). The processor 120 of the electronic device 101 may identify a difference between the orientation of the external electronic device 104 identified based on the received communication signal and the orientation of the electronic device 101. The external electronic device 104 may receive a communication signal including information on the orientation of the electronic device 101 through a communication module (e.g., a communication module corresponding to 190 of FIG. 1). The processor 120 of the electronic device 101 may identify the orientation of the electronic device 101, and may transmit a communication signal including information on the orientation through a communication module (e.g., 190 of FIG. 1). The processor 120b of the external electronic device 104 may identify a difference between the orientation of the electronic device 101 identified based on the received communication signal and the orientation of the external electronic device 104.

Referring to FIG. 3, according to an embodiment, the second communication circuit 320a and the second communication circuit 320b may transmit/receive communication signals based on a UWB communication scheme. The processor 120 and/or the second communication circuit 320a of the electronic device 101 may identify a position of the external electronic device 104 (e.g., a distance from the electronic device 101 to the external electronic device 104 and/or a direction (or angle) of the external electronic device 104 with respect to the electronic device 101), based on a measurement result of a communication signal (e.g., a UWB signal) from an external source. The processor 120b and/or the second communication circuit 320b of the external electronic device 104 may identify a position of the electronic device 101 (e.g., a distance from the external electronic device 104 to the electronic device 101 and/or a direction (or angle) of the electronic device 101 with respect to the external electronic device 104), based on a measurement result of a communication signal (e.g., a UWB signal) from an external source.

The processor 120 or the processor 120b according to an embodiment may be implemented by various circuits capable of performing an operation, such as a general-purpose processor like a CPU, a mini computer, a microprocessor, a micro controlling unit (MCU), a field programmable gate array (FPGA), and there is no limitation on a type thereof.

According to an embodiment, as illustrated in FIG. 4, the second communication circuit 320a of the electronic device 101 may include a distance measurement dedicated antenna 421, and patch antennas 422, 423, 424. The second communication circuit 320b of the external electronic device 104 may include a distance measurement dedicated antenna 441, and patch antennas 442, 443, 444. The distance measurement dedicated antennas 421, 441 may be implemented by, e.g., a metal antenna or a laser direct structuring (LDS) antenna, but there is no limitation on an implementation form thereof. The distance measurement dedicated antennas 421, 441 may be implemented to be used for a radio access technology (RAT) based on 3GPP (e.g., E-UTRA, or NR) in addition to a UWB communication scheme. In this case, the distance measurement dedicated antennas 421, 441 may be used as a shared antenna for a RAT based on 3GPP and UWB communication. The patch antennas 422, 423, 424, 442, 443, 444 may be implemented by, e.g., a patch antenna, but there is no limitation on an implementation form thereof. For example, a portion described as the patch antennas 422, 423, 424, 442, 443, 444 may be implemented by a dipole antenna, a slot antenna, and/or a slit antenna, and there is no limitation on a type thereof. The second communication circuit 320a of the electronic device 101 may include a radio frequency (RF) path for transmitting an RF signal to the distance measurement dedicated antenna 421 and an RF path for receiving an RF signal, and accordingly, the distance measurement dedicated antenna 421 may be used for both transmission/reception of a communication signal. The second communication circuit 320a of the electronic device 101 may include an RF path for transmitting an RF signal to the patch antenna 422 and an RF path for receiving an RF signal, and accordingly, the patch antenna 422 may be used for both transmission/reception of a communication signal. The second communication circuit 320a of the electronic device 101 may include an RF path for receiving an RF signal from the patch antennas 423, 424, and accordingly, the patch antennas 423, 424 may be used for reception of a communication signal. The second communication circuit 320b of the external electronic device 104 may include an RF path for transmitting an RF signal to the distance measurement dedicated antenna 441 and an RF path for receiving an RF signal, and accordingly, the distance measurement dedicated antenna 441 may be used for both transmission/reception of a communication signal. The second communication circuit 320b of the external electronic device 104 may include an RF path for transmitting an RF signal to the patch antenna 442 and an RF path for receiving an RF signal, and accordingly, the patch antenna 442 may be used for both transmission/reception of a communication signal. The second communication circuit 320b of the external electronic device 104 may include an RF path for receiving an RF signal from the patch antennas 443, 444, and accordingly, the patch antennas 443, 444 may be used for reception of a communication signal.

According to an embodiment, the second communication circuit 320a of the electronic device 101 may transmit a communication signal 461 (e.g., the poll message of FIG. 2A or FIG. 2B) using the distance measurement dedicated antenna 421. The second communication circuit 320b of the external electronic device 104 may receive the communication signal 461 using the distance measurement dedicated antenna 441. The second communication circuit 320b of the external electronic device 104 may transmit a communication signal 462 (e.g., the response message of FIG. 2A or FIG. 2B) using the distance measurement dedicated antenna 441. The second communication circuit 320a of the electronic device 101 may receive the communication signal 462 using the distance measurement dedicated antenna 421. The second communication circuit 320a of the electronic device 101 may transmit a communication signal 463 (e.g., the final message of FIG. 2B) using the distance measurement dedicated antenna 421. The second communication circuit 320b of the external electronic device 104 may receive the communication signal 463 using the distance measurement dedicated antenna 441. The second communication circuit 320a of the electronic device 101 may identify a distance between the electronic device 101 and the external electronic device 104, based on a time of transmitting the communication signal 461, a time of receiving the communication signal 462, and a process time of the external electronic device 104 obtained from the communication signal 462. The second communication circuit 320b of the external electronic device 104 may identify a distance between the electronic device 101 and the external electronic device 104, based on a time of transmitting the communication signal 462, a time of receiving the communication signal 463, and a process time of the electronic device 104 obtained from the communication signal 463. The second communication circuit 320a of the electronic device 101 may identify a distance between the electronic device 101 and the external electronic device 104, using the distance measurement dedicated antenna 421.

According to an embodiment, the second communication circuit 320a of the electronic device 101 may transmit a communication signal 464 using the patch antenna 422. The communication signal 464 may be measured at the patch antennas 442, 443, 444 of the second communication circuit 320b. A measurement time and/or a measurement phase of the communication signal 464 may be different based on an antenna spacing between the patch antennas 442, 443, 444. The second communication circuit 320b of the external electronic device 104 may identify a direction (or angle) of the electronic device 101 with respect to the external electronic device 104, based on a difference in a measurement time and/or a measurement phase corresponding to the patch antennas 442, 443, 444. The second communication circuit 320b of the external electronic device 104 may transmit a communication signal 465 using the patch antenna 442, and a measurement time and/or a measurement phase of the communication signal 465 may be different based on an antenna spacing between the patch antennas 422, 423, 424. The second communication circuit 320a of the electronic device 101 may identify a direction (or angle) of the external electronic device 104 with respect to the electronic device 101, based on a difference in a measurement time and/or a measurement phase corresponding to the patch antennas 422, 423, 424. When the second communication circuit 320a of the electronic device 101 transmits the communication signal 464 and then the second communication circuit 320b of the external electronic device 104 transmits the communication signal 465 in response thereto, the second communication circuit 320a of the electronic device 101 may identify a distance between the electronic device 101 and the external electronic device 104, based on a time of transmitting the communication signal 464, a time of receiving the communication signal 465, and a process time of the external electronic device 104 obtained from the communication signal 465. The second communication circuit 320a of the electronic device 101 may identify at least simultaneously a distance between the electronic device 101 and the external electronic device 104, and a direction (or angle) of the external electronic device 104, using the patch antennas 422, 423, 424. When the second communication circuit 320b of the external electronic device 104 transmits the communication signal 465 and then the second communication circuit 320a of the electronic device 101 transmits the communication signal 464 in response thereto, the second communication circuit 320b of the external electronic device 104 may identify a distance between the electronic device 101 and the external electronic device 104, based on a time of transmitting the communication signal 465, a time of receiving the communication signal 464, and a process time of the electronic device 101 obtained from the communication signal 464. The second communication circuit 320b of the external electronic device 104 may identify at least simultaneously a distance between the electronic device 101 and the external electronic device 104, and a direction (or angle) of the electronic device 101, using the patch antennas 442, 443, 444.

In an embodiment of the disclosure, the electronic device 101 measuring a position of the external electronic device 104 may refer, for example, to either of measuring both a distance and a direction to the external electronic device 104 using a plurality of antennas (e.g., the patch antennas 422, 423, 424), or measuring a distance to the external electronic device 104 using a single antenna (e.g., the distance measurement dedicated antenna 421). Similarly, the external electronic device 104 measuring a position of the electronic device 101 may refer, for example, to either of measuring both a distance and a direction to the electronic device 101 using a plurality of antennas (e.g., the patch antennas 442, 443, 444), or measuring a distance to the electronic device 101 using a single antenna (e.g., the distance measurement dedicated antenna 441).

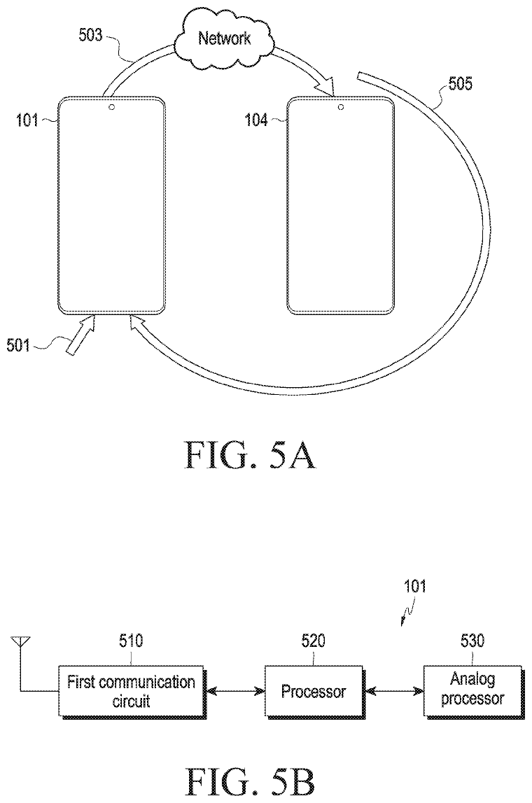

FIG. 5A is a diagram illustrating an example of howling occurrence, according to an embodiment.

Referring to FIG. 5A, the electronic device 101 and the external electronic device 104 may perform a call. In this case, when the electronic device 101 and the external electronic device 104 are located at a close distance within a predetermined distance, howling may occur. Howling may refer to a phenomenon in which a volume of a digital signal 503 is amplified in a cycle in which a voice 501 input to the electronic device 101 is converted into the digital signal 503 and transmitted to the external electronic device 104 through a network, and then a voice 505 output from the external electronic device 104 in response to the transmitted digital signal 503 is input again to the electronic device 101. Howling may refer to a phenomenon in which noise is generated by resonance of a specific voice frequency. For example, howling may refer to a phenomenon in which interference of an un-desired audio signal occurs in a specific frequency band due to a cycle in which an audio signal output from the electronic device 101 is input to the external electronic device 104.

Further, when the electronic device 101 and the external electronic device 104 are device-to-device (D2D) connected, if the electronic device 101 and the external electronic device 104 are located at a close distance within a predetermined distance, howling may occur. For example, when the electronic device 101 and the external electronic device 104 are D2D connected to establish a disaster network, if the electronic device 101 and the external electronic device 104 are located in an enclosed indoor space, howling may occur.

If howling occurs as illustrated in FIG. 5A and the howling is not removed, deterioration in call quality may occur. Accordingly, the disclosure describes various example embodiments for removing howling for enhancing call quality in greater detail below.

FIG. 5B is a block diagram illustrating an example configuration of an electronic device, according to an embodiment.

Referring to FIG. 5B, the electronic device 101 may include a first communication circuit 510 (e.g., 310a of FIG. 3), a processor (e.g., including processing circuitry) 520 (e.g., 120 of FIG. 1), and an analog processor 530. In an embodiment, the electronic device 101 is not necessarily required to have the configurations illustrated in FIG. 5B, and may be implemented to have more configurations than the configurations illustrated in FIG. 5B, or may have fewer configurations than that.

A call connection may be described with reference to FIG. 5B.

According to an embodiment, the first communication circuit 510 (e.g., 310a of FIG. 3) may receive an RF signal. To this end, the first communication circuit 510 (e.g., 310a of FIG. 3) may include at least one antenna. The first communication circuit 510 (e.g., 310a of FIG. 3) may down-convert the received signal to generate an intermediate frequency (hereinafter, ‘IF’) or a baseband signal. The first communication circuit 510 (e.g., 310a of FIG. 3) may include a reception processing circuit generating a processed baseband signal by filtering, decoding, and/or digitizing the baseband or IF signal. The reception processing circuit may transmit the processed baseband signal to a speaker for voice data, or to the processor 520 (e.g., 120 of FIG. 1) for further processing. Further, the first communication circuit 510 (e.g., 310a of FIG. 3) may include at least one transceiver. The at least one transceiver may receive outgoing baseband data from the processor 520 (e.g., 120 of FIG. 1). The transmission processing circuit may encode, multiplex, and digitize the outgoing baseband data to generate a processed baseband or intermediate frequency signal. The first communication unit 510 may up-convert the processed baseband or intermediate frequency signal for transmission through the transmission processing circuit into an RF signal transmittable through an antenna.

According to an embodiment, the processor 520 (e.g., 120 of FIG. 1) may control the first communication circuit 510 (e.g., 310a of FIG. 3) and the analog processor 530 functionally coupled to the processor 520 (e.g., 120 of FIG. 1). For example, the processor 520 (e.g., 120 of FIG. 1) may control reception of a forward channel signal and transmission of a reverse channel signal using the first communication circuit 510 (e.g., 310a of FIG. 3). The processor 520 (e.g., 120 of FIG. 1) may execute other processes or programs present in the electronic device 101. The processor 520 (e.g., 120 of FIG. 1) may store data in or retrieve data from the electronic device 101 as required by an execution process. In various embodiments, the processor 520 (e.g., 120 of FIG. 1) may be configured to execute an application in response to a signal received based on an operating system.

According to an embodiment, the analog processor 530 may receive a voice signal input from a user of the electronic device 101 or a voice signal from the external electronic device 104. The analog processor 530 may convert the received voice signal from an analog form to a digital form, and then adjust a level according to a set gain.

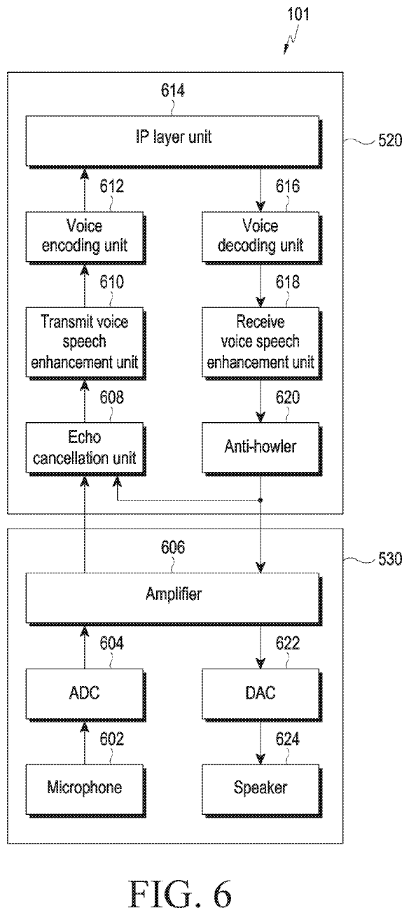

In FIG. 6, a description of interlocking between the processor 520 (e.g., 120 of FIG. 1) and the analog processor 530 is illustrated and described in greater detail.

FIG. 6 is a block diagram illustrating an example configuration of an electronic device, according to an embodiment.

Referring to FIG. 6, the analog processor 530 may include a microphone 602, an analog to digital converter (ADC) 604, an amplifier 606, a digital to analog converter (DAC) 622, and a speaker 624. The processor 520 (e.g., 120 of FIG. 1) may include an echo cancellation unit 608, a transmit voice speech enhancement unit 610, a voice encoding unit 612, an internet protocol (IP) layer unit 614, a voice decoding unit 616, a receive voice speech enhancement unit 618, and an anti-howler 620, each of which may include various circuitry and/or executable program instructions. Configurations included in the processor 520 (e.g., 120 of FIG. 1) and the analog processor 530 may be in the form of hardware and/or software, and in case of the form of software, each configuration may be performed by the processor 520 (e.g., 120 of FIG. 1) or the analog processor 530.

According to an embodiment, the microphone 602 (e.g., 330a of FIG. 3) may include a circuit such as a piezoelectric element, and may generate an audio signal using vibration of a diaphragm by a voice signal. The microphone 602 may receive a voice signal from the external electronic device 104. The microphone 602 may transfer the received voice signal to the ADC 604. The microphone 602 may convert a voice signal received in the form of a sound wave into an electrical signal, and transfer the electrical signal to the ADC 604.

According to an embodiment, the ADC 604 may convert the electrical signal received from the microphone 602 from an analog form to a digital form. The ADC 604 may convert an analog voice signal received from the microphone 602 into a digital voice signal by performing sampling, quantizing, and binary encoding thereon. The ADC 604 may transfer the digital voice signal to the amplifier 606.

According to an embodiment, the amplifier 606 may receive the digital voice signal from the ADC 604. The amplifier 606 may control a gain of the received digital voice signal. The amplifier 606 may increase the gain of the received digital voice signal. The gain may be different according to a frequency band of the digital voice signal. The amplifier 606 may transfer the digital voice signal with the changed gain to the echo cancellation unit 610.

According to an embodiment, the echo cancellation unit 608 may remove an echo from the digital voice signal received from the amplifier 606. An echo may refer to noise generated by a voice output from the speaker 624 (e.g., 340a of FIG. 3) and input again to the microphone 602. The echo cancellation unit 608 may remove the echo using a voice output from the speaker 624 and input again to the microphone 602 as a reference signal. The echo cancellation unit 608 may transfer the digital voice signal from which the echo has been removed to the transmit voice speech enhancement unit 610.

According to an embodiment, the transmit voice speech enhancement unit 610 may receive the digital voice signal from which the echo has been removed from the echo cancellation unit 608, and then remove noise from the digital voice signal. In an embodiment, the transmit voice speech enhancement unit 610 may adjust a volume and a tone of the digital voice signal. The transmit voice speech enhancement unit 610 may transfer the digital voice signal from which the noise has been removed to the voice encoding unit 612.

According to an embodiment, the voice encoding unit 612 may receive the digital voice signal from which the noise has been removed from the transmit voice speech enhancement unit 610, and then encode the digital voice signal. The voice encoding unit 612 may compress the digital voice signal. The voice encoding unit 612 may transfer the compressed digital voice signal to the IP layer unit 614.

According to an embodiment, the IP layer unit 614 may process an IP packet. For example, the IP layer unit 614 may receive the compressed digital voice signal from the voice encoding unit 612, packetize the digital voice signal, and transmit a packet including the compressed digital voice signal to the external electronic device 104 through a network (e.g., the first communication circuit 310a). Thereafter, the IP layer unit 614 may receive a packet including a digital signal from the external electronic device 104 through a network (e.g., the first communication circuit 310a), restore the digital voice signal included in a payload of the packet, and then transfer the digital voice signal to the voice decoding unit 616.

According to an embodiment, the voice decoding unit 616 may receive the digital signal from the IP layer unit 614, and then decode the digital voice signal. The voice decoding unit 616 may decompress the digital voice signal. The voice decoding unit 616 may transfer the decompressed digital voice signal to the receive voice speech enhancement unit 618.

According to an embodiment, the receive voice speech enhancement unit 618 may receive the decompressed digital voice signal from the voice decoding unit 616, and then remove noise from the digital voice signal. In an embodiment, the receive voice speech enhancement unit 618 may adjust a volume and a tone of the digital voice signal. The receive voice speech enhancement unit 618 may transfer the digital voice signal from which the noise has been removed to the anti-howler 620.

According to an embodiment, the anti-howler 620 may receive the digital voice signal from which the noise has been removed from the receive voice speech enhancement unit 618, and then remove howling from the digital voice signal. The anti-howler 620 may determine a howling frequency band based on a power for each frequency band of the digital voice signal, and may remove the howling by adjusting a gain and a volume for the howling frequency band. The anti-howler 620 may transfer the digital voice signal from which the howling has been removed to the DAC 622. In an embodiment, the anti-howler 620 may transfer the digital voice signal from which the howling has been removed to the echo cancellation unit 610, so that an echo is additionally removed. In the example described with reference to FIG. 6, the anti-howler 620 may be disposed on a path processing a received packet, e.g., a receive path. According to an embodiment, the anti-howler 620 may be disposed on a transmit path. For example, the anti-howler 620 may be located between the transmit voice speech enhancement unit 610 and the voice encoding unit 612. For example, the anti-howler 620 may perform an operation of removing howling from a voice signal input through the microphone 602. According to an embodiment, the anti-howler 620 may be disposed on the receive path and the transmit path. In the following embodiments, there is no limitation on a location where the anti-howler 620 is disposed.

According to an embodiment, the DAC 622 may receive the digital voice signal from which the howling has been removed from the anti-howler 620, and then convert the digital voice signal into an analog voice signal. The DAC 622 may receive a digital binary code and convert it into an analog voice signal. For example, the DAC 622 may convert a digital voice signal of n bits into 2-n analog voltage reference signals. The DAC 622 may transfer the analog voice signal to the speaker 624.

According to an embodiment, the speaker 624 (e.g., 340a of FIG. 3) may receive the analog voice signal from the DAC 622, and then output it to an outside of the electronic device 101. In this case, since the voice signal output to the outside is a voice signal from which the howling has been removed, it is possible to prevent and/or reduce deterioration in call quality during a call.

An electronic device 101 for controlling a voice signal during a call according to an embodiment may include a processor 520 (e.g., 120 of FIG. 1) receiving a voice signal including a howling component from the external electronic device 104 through the first communication circuit 510, and an analog processor 530 outputting the voice signal filtered by a filter based on a frequency of the howling component. The filtered voice signal may be output with a gain of the frequency band of the howling component being adjusted.

The howling component according to an embodiment may be generated by a voice signal output from the electronic device 101 (or the external electronic device 104) being input to the external electronic device 104 (or the electronic device 101) in a call with the electronic device 101 (or the external electronic device 104).

The electronic device 101 according to an embodiment may determine a howling frequency band for a voice signal, may adjust a gain for the howling frequency band, and may adjust a volume for the howling frequency band and a frequency band other than the howling frequency band.

The electronic device 101 according to an embodiment may determine a first sub frequency band having a first maximum power among a plurality of sub frequency bands of a first frequency band for a voice signal, may determine a second sub frequency band having a second maximum power among a plurality of sub frequency bands of a second frequency band for a voice signal, and may determine a third frequency band based on the first sub frequency band and the second sub frequency band when the first maximum power and the second maximum power are greater than a first reference value (or a first threshold).

The processor 520 (e.g., 120 of FIG. 1) according to an embodiment may determine a power for each of a plurality of sub frequency bands of the third frequency band, and may determine a third sub frequency band corresponding to the power as the howling frequency band when the power is greater than a second reference value (or a second threshold).

The processor 520 (e.g., 120 of FIG. 1) according to an embodiment may determine a first sub frequency band having a first maximum power among a plurality of sub frequency bands of a first frequency band for the voice signal, may determine a second sub frequency band having a second maximum power among a plurality of sub frequency bands of a second frequency band for the voice signal, and may determine a third frequency band based on the first sub frequency band and the second sub frequency band when the first maximum power and the second maximum power are greater than a first reference value.

The processor 520 (e.g., 120 of FIG. 1) according to an embodiment may determine a power for each of a plurality of sub frequency bands of the third frequency band, and may determine a third sub frequency band corresponding to the power as the howling frequency band when the power is greater than a second reference value.

The first frequency band and the second frequency band according to an embodiment may overlap at least partially.

A size of each of the plurality of sub frequency bands of the third frequency band according to an embodiment may be smaller than a size of each of the plurality of sub frequency bands of the first frequency band and the second frequency band.

The processor 520 (e.g., 120 of FIG. 1) according to an embodiment may determine a first gain for the howling frequency band and a second gain for the frequency band other than the howling frequency band, and may perform filtering on the howling frequency band and the frequency band other than the howling frequency band based on the first gain and the second gain.

The first gain according to an embodiment may be determined according to each of a plurality of sub frequency bands of the howling frequency band.

The processor 520 (e.g., 120 of FIG. 1) according to an embodiment may adjust a volume of the howling frequency band and the frequency band other than the howling frequency band by a first value, may detect additionally generated howling, and may adjust a volume of the howling frequency band and the frequency band other than the howling frequency band by a second value according to the detection.

According to an embodiment, the electronic device 101 may receive a voice signal from the external electronic device 104. The voice signal may be received through a direct link with the external electronic device 104, or may be received through a network. The voice signal may be received in the form of a data packet, and the electronic device 101 may extract the voice signal from the data packet. The voice signal may include a howling component. The voice signal includes a voice of a counterpart of the external electronic device 104, and may further include an interference signal from a voice output through a speaker (e.g., 340a of FIG. 3) of the electronic device 101 being input to a microphone (e.g., 330b of FIG. 3) of the external electronic device 104. The howling component may refer to noise generated by a voice signal output from the electronic device 101 (or the external electronic device 104) being input to the external electronic device 104 (or the electronic device 101) in a call with the electronic device 101 (or the external electronic device 104).

According to an embodiment, the electronic device 101 may process a howling frequency band in the received voice signal. The electronic device 101 removes or reduces a howling component in the received voice signal. To this end, the electronic device 101 may convert the received voice signal into a signal in a frequency domain. The received voice may be converted to a time-frequency domain. For example, howling may occur in a howling frequency band. The electronic device 101 may determine the howling frequency band among a plurality of frequency bands for the converted signal. The howling frequency band may be determined based on a power related to each of the plurality of frequency bands. The electronic device 101 may adjust a gain corresponding to the determined howling frequency band. Further, the electronic device 101 may adjust a volume so that howling does not occur.

According to an embodiment, the electronic device 101 may output a voice signal in which the howling frequency band has been processed. The processed voice signal may refer to a voice in which a gain corresponding to the howling frequency band has been adjusted and additionally a volume has been decreased.

In an embodiment, the electronic device 101 may process the howling frequency band according to determining that a call is being performed. Performance of a call connection may be defined as a triggering condition for a howling removal or reduction operation.

According to an embodiment, the electronic device 101 may determine a howling frequency band. The electronic device 101 may convert a voice signal received from the external electronic device 104 into a frequency domain, and then determine a power for each of a plurality of frequency bands. The electronic device 101 may determine a specific frequency band based on a power for each of the plurality of frequency bands, and then determine a power for each of a plurality of sub frequency bands of the specific frequency band. The electronic device 101 may determine a howling frequency band based on a power for each of the plurality of sub frequency bands.

According to an embodiment, the electronic device 101 may remove the howling frequency band. The electronic device 101 may determine a gain corresponding to the howling frequency band and another gain corresponding to a band other than the howling frequency band, and then perform filtering by applying the determined gains.

According to an embodiment, the electronic device 101 may adjust a volume. The electronic device 101 may adjust a volume corresponding to the filtered howling frequency band and a band other than the howling frequency band. The electronic device 101 may adjust a volume for an entire frequency band. In an embodiment, the electronic device 101 may adjust a volume for a band other than the filtered howling frequency band. In an embodiment, when howling is additionally generated in a band other than the filtered howling frequency band, or when howling is not suppressed, the electronic device 101 may reduce a volume to decrease a gain for the howling frequency band and a band other than the howling frequency band more than a gain previously decreased. A volume adjustment operation may be omitted.

According to an embodiment, the electronic device 101 may determine a gain for each frequency band. Specifically, the electronic device 101 may determine a gain for the howling frequency band and another gain for a band other than the howling frequency band. For example, the electronic device 101 may determine the gain for the howling frequency band as 0.05, and determine the other gain for a band other than the howling frequency band as 1.

According to an embodiment, the electronic device 101 may perform filtering for each frequency band. The electronic device 101 may apply the determined gain to the howling frequency band, and may apply the other gain to a band other than the howling frequency band. The electronic device 101 may perform filtering on the howling frequency band and a frequency band other than the howling frequency band based on the determined gains. For example, a band in which howling occurs may have a gain of 0 applied, and a band other than the band in which howling occurs may have a gain of 1 applied. For example, a band other than the band in which howling occurs may have a gain of 1 applied. The band in which howling occurs may have a gain applied so that the gain is gradually decreased for a portion of two opposite ends of the band, rather than having a gain of 0 applied to the entire band. A gain for the howling frequency band may be determined according to each bin of the howling frequency band. In this case, there may be an advantage in that distortion generated by the gain abruptly changing at a boundary between the band in which howling occurs and a band other than the band in which howling occurs is suppressed.

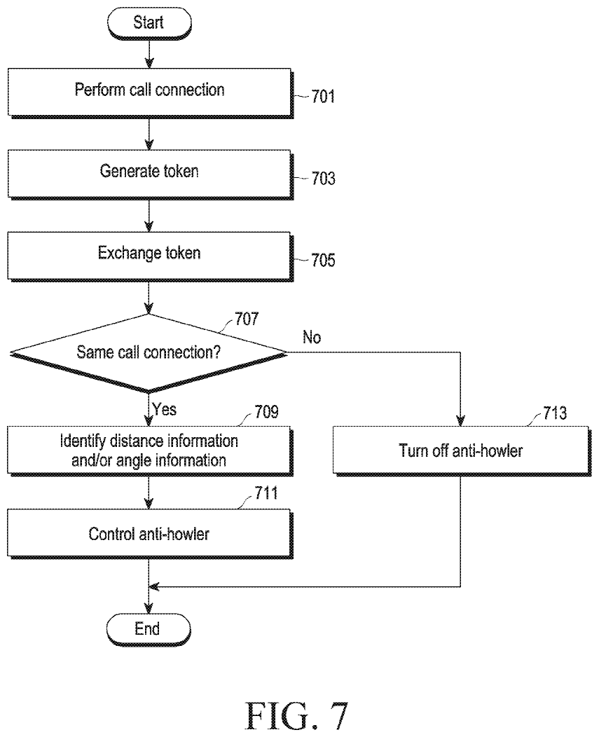

FIG. 7 is a flowchart illustrating an example method of operating the electronic device 101, according to an embodiment. FIG. 7 may be described with reference to the previously described examples.

At least a portion of the operations of FIG. 7 may be omitted. An operation order of the operations of FIG. 7 may be changed. Operations other than the operations of FIG. 7 may be performed before, while, or after performing the operations of FIG. 7.

Referring to FIG. 7, in operation 701, according to an embodiment, the electronic device 101 (e.g., the processor 120) may perform a call connection to the external electronic device 104. The electronic device 101 may receive a voice signal from the external electronic device 104 and may transmit a voice signal to the external electronic device 104 through a network (e.g., the first communication circuit 310a).

In operation 703, according to an embodiment, the electronic device 101 (e.g., the processor 120) may generate (or identify) a token (or information or data) including information related to the call connection to the external electronic device 104. A “token” may include, for example, and without limitation, information, data, a set of information or data) or the like. Generating (or identifying) a token may include identifying information. Generating (or identifying) a token may include reconfiguring information into a form for transmitting information to an outside. Information related to a call connection may include information (e.g., a phone number and/or international mobile equipment identity (IMEI) information) of the electronic device 101, which is a first subject of the call connection, and/or information (e.g., a phone number and/or IMEI information) of the external electronic device 104, which is a second subject of the call connection. For example, the electronic device 101 may generate (or identify) a token including information (e.g., a phone number and/or IMEI information) of the electronic device 101. For example, the electronic device 101 may generate (or identify) a token including information (e.g., a phone number and/or IMEI information) of the external electronic device 104 related to the call connection of operation 701. For example, the electronic device 101 may generate (or identify) a token including information (e.g., a phone number and/or IMEI information) of the electronic device 101 and information (e.g., a phone number and/or IMEI information) of the external electronic device 104 related to the call connection of operation 701. For example, the token (or information related to a call connection) of operation 703 may include only the information of the electronic device 101, may include only the information of the external electronic device 104 which is a counterpart of the call connection, or may include both the information of the electronic device 101 and the information of the external electronic device 104 which is a counterpart of the call connection.

In operation 705, according to an embodiment, the electronic device 101 (e.g., the processor 120) may exchange a token with an external device (e.g., the external electronic device 104 or another electronic device), using the second communication circuit 320a (e.g., a communication circuit supporting a UWB communication scheme). For example, the electronic device 101 may transmit the token (e.g., a first token) of operation 703 to an external device (e.g., the external electronic device 104 or another electronic device), using the second communication circuit 320a supporting a UWB communication scheme. For example, the electronic device 101 may receive a token (e.g., a second token) from an external device (e.g., the external electronic device 104 or another electronic device), using the second communication circuit 320a supporting a UWB communication scheme. An external device (e.g., the external electronic device 104 or another electronic device) may perform a call connection, generate/or identify) a token including information related to the call connection, and transmit the token to an outside (e.g., the electronic device 101), similarly to operations 701 and 703. Information related to a call connection included in a token (e.g., a second token) received by the electronic device 101 from an external device (e.g., the external electronic device 104 or another electronic device) may be information related to a call connection of the external device (e.g., the external electronic device 104 or another electronic device). For example, the electronic device 101 may receive a token from the external electronic device 104, and in this case, information related to a call connection included in the received token may correspond to the information related to a call connection of operation 703. For example, the electronic device 101 may receive a token from another electronic device other than the external electronic device 104, and in this case, information related to a call connection included in the received token may not correspond to the information related to a call connection of operation 703.

According to an embodiment, the electronic device 101 (e.g., the processor 120) may exchange the token of operation 705 through a communication circuit (e.g., a communication circuit included in the communication module 190 of FIG. 1) supporting a communication scheme other than a UWB communication scheme. In this case, information on whether a UWB communication scheme is supported may be included in the exchanged token.

In operation 707, according to an embodiment, the electronic device 101 (e.g., the processor 120) may identify whether the call connection is the same call connection, based on the token (or information included in the token) exchanged in operation 705. For example, the electronic device 101 may identify information related to a call connection of an external device (e.g., the external electronic device 104 or another electronic device) transmitting the token (e.g., the second token), based on the token (e.g., the second token) received in operation 705. Information related to a call connection of an external device (e.g., the external electronic device 104 or another electronic device) may include information (e.g., a phone number and/or IMEI information) of the external device (e.g., the external electronic device 104 or another electronic device) and/or information (e.g., a phone number and/or IMEI information) of a device (e.g., the electronic device 101 or yet another electronic device) related to a call connection to the external device (e.g., the external electronic device 104 or another electronic device). The electronic device 101 may identify whether information related to a call connection included in the token (e.g., the second token) received in operation 705 corresponds to the information related to the call connection to the external electronic device 104 of operation 703, or the information (e.g., a phone number and/or IMEI information) of the electronic device 101. The electronic device 101 may identify whether information included in a token received from an external source corresponds to information of a subject(s) (e.g., the electronic device 101 and/or the external electronic device 104) of a communication connection that the electronic device 101 is currently performing. The electronic device 101 may identify, through operation 707, whether the external device (e.g., the external electronic device 104 or another electronic device) with which the token is exchanged and the electronic device 101 are in a call. The electronic device 101 may identify, through operation 707, whether the external device with which the token is exchanged in operation 705 is the external electronic device 104 related to the call connection of operation 701. For example, the electronic device 101 may identify that the external device with which the token is exchanged in operation 705 is the external electronic device 104 related to the call connection of operation 701, based on information related to a call connection included in the received token (e.g., the second token) corresponding to the information related to the call connection to the external electronic device 104, or the information of the electronic device 101. For example, the electronic device 101 may identify that the external device with which the token is exchanged in operation 705 is not the external electronic device 104 related to the call connection of operation 701, based on information related to a call connection included in the received token (e.g., the second token) not corresponding to the information related to the call connection to the external electronic device 104, or the information of the electronic device 101. Based on the same call connection being identified in operation 707, operation 709 may be performed. Based on it being identified that the call connection is not the same call connection in operation 707, operation 713 may be performed.

In operation 709, according to an embodiment, the electronic device 101 (e.g., the processor 120) may identify distance information and/or angle information (or direction information) between the external electronic device 104 and the electronic device 101, using the second communication circuit 320a. The distance information may include information on a distance between the external electronic device 104 and the electronic device 101 (e.g., a value corresponding to the distance, or information indicating that the distance is not identified). The angle information (or direction information) may include information on a direction (or angle) of the external electronic device 104 with respect to the electronic device 101 (e.g., a value corresponding to the direction (or angle), or information indicating that the direction (or angle) is not identified). An embodiment of identifying a distance or an angle (or direction) using the second communication circuit 320a supporting a UWB scheme may be understood with reference to FIGS. 2A, 2B, 2C, and 4. The electronic device 101 may identify only the distance information, may identify only the angle information, or may identify both the distance information and the angle information. According to an embodiment, the electronic device 101 may perform operation 709 before, during, and/or after performing at least one of operation 701, operation 703, operation 705, or operation 707. According to an embodiment, the electronic device 101 may start performing operation 709, based on the same call connection being identified in operation 707.

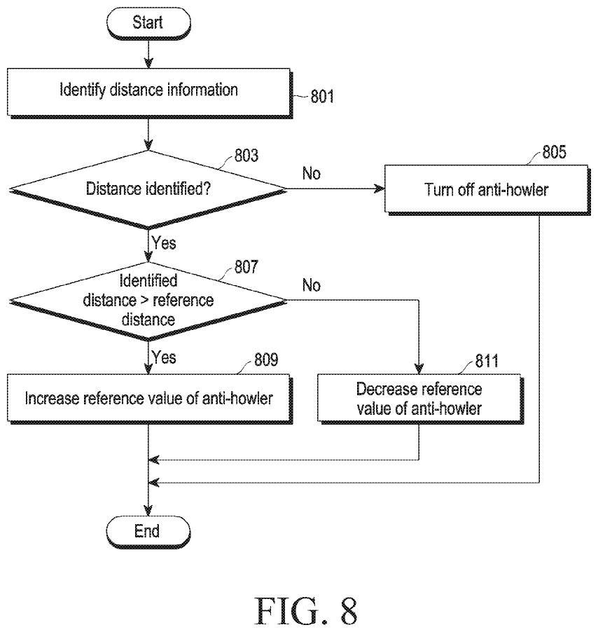

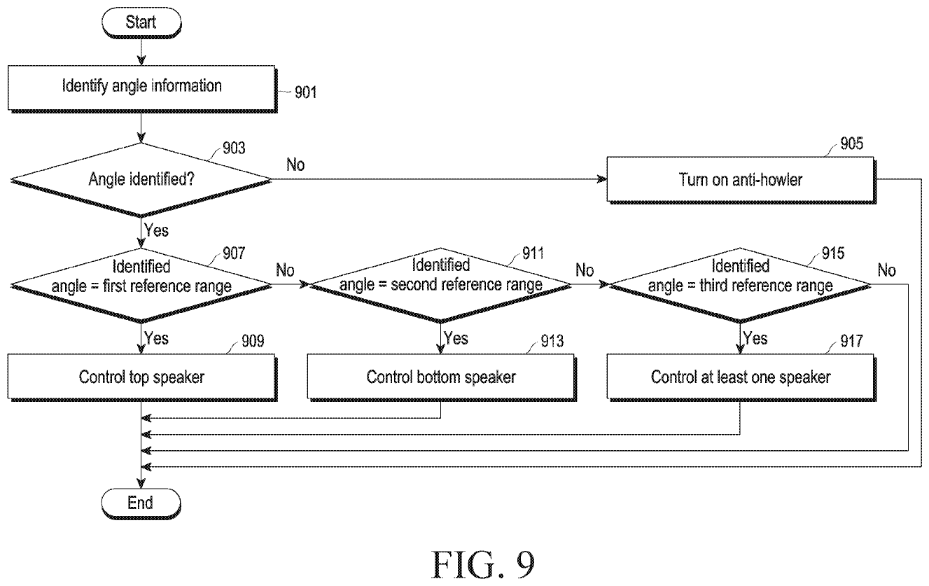

In operation 711, according to an embodiment, the electronic device 101 (e.g., the processor 120) may control the anti-howler (e.g., 620 of FIG. 6) related to the call connection of operation 701, based on the distance information and/or the angle information of operation 709. An embodiment related to control of the anti-howler (e.g., 620 of FIG. 6) based on the distance information is described in greater detail below with reference to FIG. 8. An embodiment related to control of the anti-howler (e.g., 620 of FIG. 6) based on the angle information is described in greater detail below with reference to FIGS. 9, 10A, 10B, and 11. For example, the electronic device 101 may reflect the distance information and/or the angle information in a solution of the anti-howler (e.g., 620 of FIG. 6). As the electronic device 101 controls the anti-howler (e.g., 620 of FIG. 6), howling related to a call may be effectively removed or decreased.

In operation 713, according to an embodiment, the electronic device 101 (e.g., the processor 120) may control the anti-howler (e.g., 620 of FIG. 6) to be off, based on information related to a call connection included in the received token (e.g., the second token) not corresponding to the information related to the call connection to the external electronic device 104, or the information of the electronic device 101. For example, in a state in which the anti-howler (e.g., 620 of FIG. 6) is controlled to be on before operation 707, the electronic device 101 may control the anti-howler (e.g., 620 of FIG. 6) to be off through operation 713. For example, in a state in which the anti-howler (e.g., 620 of FIG. 6) is controlled to be off before operation 707, the electronic device 101 may maintain the anti-howler (e.g., 620 of FIG. 6) to be off through operation 713. On or off of the anti-howler (e.g., 620 of FIG. 6) may be that a function of the anti-howler (e.g., 620 of FIG. 6) is performed or is stopped (or is not performed) by the electronic device 101 (e.g., the processor 120). As the anti-howler (e.g., 620 of FIG. 6) is controlled to be off, power consumption of the electronic device 101 may be decreased, or a computation amount of the processor 120 may be decreased.

FIG. 8 is a flowchart illustrating an example method of operating the electronic device 101, according to an embodiment. FIG. 8 may be described with reference to the previously described examples.

At least a portion of the operations of FIG. 8 may be omitted. The operation order of the operations of FIG. 8 may be changed. Operations other than the operations of FIG. 8 may be performed before, while, or after performing the operations of FIG. 8.

Referring to FIG. 8, in operation 801, according to an embodiment, the electronic device 101 (e.g., the processor 120) may identify distance information corresponding to the external electronic device 104, using the second communication circuit 320a supporting a UWB scheme. Operation 801 may be a portion of operation 709 of FIG. 7. For example, the electronic device 101 may identify a distance from the electronic device 101 to the external electronic device 104, based on signal(s) transmitted and received using the second communication circuit 320a supporting a UWB scheme. For example, the electronic device 101 may not identify a distance from the electronic device 101 to the external electronic device 104, despite transmitting (or receiving) signal(s) using the second communication circuit 320a.

In operation 803, according to an embodiment, the electronic device 101 (e.g., the processor 120) may perform operation 805 based on the distance from the electronic device 101 to the external electronic device 104 not being identified based on the distance information, and may perform operation 807 based on the distance from the electronic device 101 to the external electronic device 104 being identified.

In operation 805, according to an embodiment, the electronic device 101 (e.g., the processor 120) may control the anti-howler (e.g., 620 of FIG. 6) to be off, based on the distance from the electronic device 101 to the external electronic device 104 not being identified. As the anti-howler (e.g., 620 of FIG. 6) is controlled to be off, power consumption of the electronic device 101 may be decreased, or a computation amount of the processor 120 may be decreased.

In operation 807, according to an embodiment, the electronic device 101 (e.g., the processor 120) may compare the distance from the electronic device 101 to the external electronic device 104 (e.g., an identified distance) with a reference distance.

In operation 809, according to an embodiment, the electronic device 101 (e.g., the processor 120) may increase a reference value (or a threshold) of the anti-howler (e.g., 620 of FIG. 6), based on the distance from the electronic device 101 to the external electronic device 104 (e.g., an identified distance) being greater than the reference distance. The reference value (or threshold) of the anti-howler (e.g., 620 of FIG. 6) may be understood with reference to FIG. 6. Based on the reference value (or threshold) of the anti-howler (e.g., 620 of FIG. 6) being increased, howling detection capability may be lowered and voice preservation capability may be increased. The howling detection capability may be a degree (or capability) where howling is detected, howling is removed, or howling is decreased by an operation of the anti-howler (e.g., 620 of FIG. 6). The voice preservation capability may be a degree (or capability) where voice included in a voice signal is preserved by an operation of the anti-howler (e.g., 620 of FIG. 6).

In operation 811, according to an embodiment, the electronic device 101 (e.g., the processor 120) may decrease the reference value (or threshold) of the anti-howler (e.g., 620 of FIG. 6), based on the distance from the electronic device 101 to the external electronic device 104 (e.g., an identified distance) being within the reference distance. Based on the reference value (or threshold) of the anti-howler (e.g., 620 of FIG. 6) being decreased, howling detection capability may be increased and voice preservation capability may be lowered.

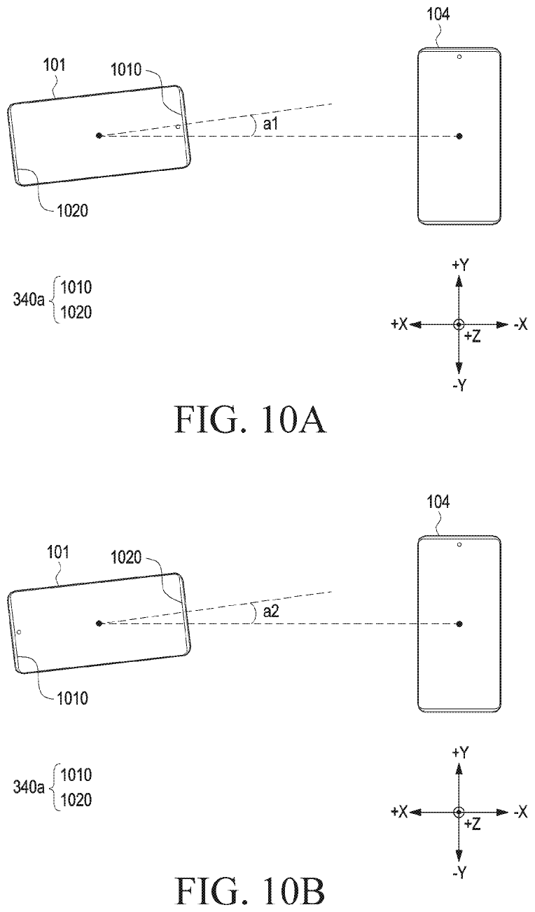

FIG. 9 is a flowchart illustrating an example method of operating the electronic device 101, according to an embodiment. FIG. 9 may be described with reference to FIGS. 10A, 10B, and the previously described examples. FIG. 10A is a diagram illustrating an example operation of the electronic device 101, according to an embodiment. FIG. 10B is a diagram illustrating an example operation of the electronic device 101, according to an embodiment.

FIG. 10A is a diagram in which a top side of the electronic device 101 faces the external electronic device 104. FIG. 10B is a diagram in which a bottom side of the electronic device 101 faces the external electronic device 104. With reference to FIGS. 9, 10A, and 10B, an operation of controlling at least one speaker (e.g., 340a of FIG. 3) of the electronic device 101 based on an angle (or direction) of the external electronic device 104 with respect to the electronic device 101 may be described.

At least a portion of the operations of FIG. 9 may be omitted. The operation order of the operations of FIG. 9 may be changed. Operations other than the operations of FIG. 9 may be performed before, while, or after performing the operations of FIG. 9.

Referring to FIG. 9, in operation 901, according to an embodiment, the electronic device 101 (e.g., the processor 120) may identify angle information (or direction information) corresponding to the external electronic device 104, using the second communication circuit 320a supporting a UWB scheme. Operation 901 may be a portion of operation 709 of FIG. 7. For example, the electronic device 101 may identify an angle (or direction) of the external electronic device 104 with respect to the electronic device 101, based on signal(s) transmitted and received using the second communication circuit 320a supporting a UWB scheme. For example, the electronic device 101 may not identify an angle (or direction) of the external electronic device 104 with respect to the electronic device 101, despite transmitting (or receiving) signal(s) using the second communication circuit 320a.

In operation 903, according to an embodiment, the electronic device 101 (e.g., the processor 120) may perform operation 905 based on the angle (or direction) of the external electronic device 104 with respect to the electronic device 101 not being identified based on the angle information, and may perform operation 907, operation 911, and/or operation 915 based on the angle (or direction) of the external electronic device 104 with respect to the electronic device 101 being identified. Although operations 907, 911, and 915 are described as being performed in sequence in FIG. 9, this is merely an example, and the electronic device 101 may identify whether the angle (or direction) of the external electronic device 104 with respect to the electronic device 101 falls within the first reference range of operation 907, the second reference range of operation 911, or the third reference range of operation 915.

In operation 905, according to an embodiment, the electronic device 101 (e.g., the processor 120) may control the anti-howler (e.g., 620 of FIG. 6) to be on, based on the angle (or direction) of the external electronic device 104 with respect to the electronic device 101 not being identified. The electronic device 101 may control the anti-howler (e.g., 620 of FIG. 6) to be on, because the external electronic device 104 may be disposed near the electronic device 101 even when the angle (or direction) of the external electronic device 104 with respect to the electronic device 101 is not identified. For example, in a state in which the anti-howler (e.g., 620 of FIG. 6) is controlled to be off before operation 903, the electronic device 101 may control the anti-howler (e.g., 620 of FIG. 6) to be on through operation 905. For example, in a state in which the anti-howler (e.g., 620 of FIG. 6) is controlled to be on before operation 903, the electronic device 101 may maintain the anti-howler (e.g., 620 of FIG. 6) to be on through operation 905.

In operation 907, according to an embodiment, the electronic device 101 (e.g., the processor 120) may compare the angle (or direction) of the external electronic device 104 with respect to the electronic device 101 with a first reference range. The first reference range may be a range corresponding to first speaker(s) (e.g., 1010 of FIG. 10A) among the at least one speaker 340a of the electronic device 101 facing the external electronic device 104. For example, as illustrated in FIG. 10A, when first speaker(s) (e.g., 1010 of FIG. 10A) among the at least one speaker 340a is disposed on an upper side among sides of the electronic device 101, the first reference range may be a range in which the upper side of the electronic device 101 faces the external electronic device 104. The first reference range may include a range of an angle (or direction) in an XY plane, a range of an angle (or direction) in a YZ plane, and a range of an angle (or direction) in a ZX plane. For example, as illustrated in FIG. 10A, based on the angle (or direction) (e.g., a1) of the external electronic device 104 with respect to the electronic device 101 being included in the first reference range, the electronic device 101 may identify that first speaker(s) (e.g., 1010 of FIG. 10A) among the at least one speaker 340a faces the external electronic device 104.

In operation 909, according to an embodiment, the electronic device 101 (e.g., the processor 120) may control the first speaker(s) (e.g., 1010 of FIG. 10A) (e.g., top speaker(s)) among the at least one speaker 340a, based on the angle (or direction) of the external electronic device 104 with respect to the electronic device 101 being included in the first reference range. For example, the electronic device 101 (e.g., the processor 120) may lower an output of the first speaker(s) (e.g., 1010 of FIG. 10A) (e.g., top speaker(s)) among the at least one speaker 340a, based on the angle (or direction) of the external electronic device 104 with respect to the electronic device 101 being included in the first reference range. According to operation 909, a volume of the first speaker(s) (e.g., 1010 of FIG. 10A) (e.g., top speaker(s)) facing the external electronic device 104 among the at least one speaker 340a of the electronic device 101 may be decreased. As the volume of the first speaker(s) (e.g., 1010 of FIG. 10A) (e.g., top speaker(s)) facing the external electronic device 104 is decreased, howling may be decreased.

In operation 911, according to an embodiment, the electronic device 101 (e.g., the processor 120) may compare the angle (or direction) of the external electronic device 104 with respect to the electronic device 101 with a second reference range. The second reference range may be a range corresponding to second speaker(s) (e.g., 1020 of FIG. 10B) among the at least one speaker 340a of the electronic device 101 facing the external electronic device 104. For example, as illustrated in FIG. 10B, when second speaker(s) (e.g., 1020 of FIG. 10B) among the at least one speaker 340a is disposed on a lower side among sides of the electronic device 101, the second reference range may be a range in which the lower side of the electronic device 101 faces the external electronic device 104. The second reference range may include a range of an angle (or direction) in an XY plane, a range of an angle (or direction) in a YZ plane, and a range of an angle (or direction) in a ZX plane. For example, as illustrated in FIG. 10B, based on the angle (or direction) (e.g., a2) of the external electronic device 104 with respect to the electronic device 101 being included in the second reference range, the electronic device 101 may identify that second speaker(s) (e.g., 1020 of FIG. 10B) among the at least one speaker 340a faces the external electronic device 104.

In operation 913, according to an embodiment, the electronic device 101 (e.g., the processor 120) may control the second speaker(s) (e.g., 1020 of FIG. 10B) (e.g., bottom speaker(s)) among the at least one speaker 340a, based on the angle (or direction) of the external electronic device 104 with respect to the electronic device 101 being included in the second reference range. For example, the electronic device 101 (e.g., the processor 120) may lower an output of the second speaker(s) (e.g., 1020 of FIG. 10B) (e.g., bottom speaker(s)) among the at least one speaker 340a, based on the angle (or direction) of the external electronic device 104 with respect to the electronic device 101 being included in the second reference range. According to operation 913, a volume of the second speaker(s) (e.g., 1020 of FIG. 10B) (e.g., bottom speaker(s)) facing the external electronic device 104 among the at least one speaker 340a of the electronic device 101 may be decreased. As the volume of the second speaker(s) (e.g., 1020 of FIG. 10B) (e.g., bottom speaker(s)) facing the external electronic device 104 is decreased, howling may be decreased.

In operation 915, according to an embodiment, the electronic device 101 (e.g., the processor 120) may compare the angle (or direction) of the external electronic device 104 with respect to the electronic device 101 with a third reference range. The third reference range may be a range not falling within the first reference range and the second reference range. The third reference range may be a range other than the first reference range and the second reference range. The third reference range may be a range in which a specific speaker among the at least one speaker 340a of the electronic device 101 is not defined as facing the external electronic device 104. The third reference range may include a range of an angle (or direction) in an XY plane, a range of an angle (or direction) in a YZ plane, and a range of an angle (or direction) in a ZX plane.

In operation 917, according to an embodiment, the electronic device 101 (e.g., the processor 120) may control the at least one speaker 340a, based on the angle (or direction) of the external electronic device 104 with respect to the electronic device 101 being included in the third reference range. Controlling the at least one speaker 340a may be controlling an output of the at least one speaker 340a. For example, controlling the at least one speaker 340a may be changing (e.g., increasing or decreasing) an output of the first speaker(s) (e.g., 1010 of FIG. 10A) (e.g., top speaker(s)) among the at least one speaker 340a, and changing (e.g., decreasing or increasing) an output of the second speaker(s) (e.g., 1020 of FIG. 10B) (e.g., bottom speaker(s)). For example, controlling the at least one speaker 340a may be controlling an output of the first speaker(s) (e.g., 1010 of FIG. 10A) (e.g., top speaker(s)) among the at least one speaker 340a to a specific level (e.g., a first level), and controlling an output of the second speaker(s) (e.g., 1020 of FIG. 10B) (e.g., bottom speaker(s)) to a specific level (e.g., a second level). The electronic device 101 may change (e.g., increase or decrease) an output of the at least one speaker 340a, or may set an output of the at least one speaker 340a to a specific level. For example, the electronic device 101 may decrease an output of the first speaker(s) (e.g., 1010 of FIG. 10A) (e.g., top speaker(s)), and an output of the second speaker(s) (e.g., 1020 of FIG. 10B) (e.g., bottom speaker(s)). For example, the electronic device 101 may decrease an output of the first speaker(s) (e.g., 1010 of FIG. 10A) (e.g., top speaker(s)), and an output of the second speaker(s) (e.g., 1020 of FIG. 10B) (e.g., bottom speaker(s)), and may set a degree of decrease in the outputs differently. For example, the electronic device 101 may increase one and decrease the other among an output of the first speaker(s) (e.g., 1010 of FIG. 10A) (e.g., top speaker(s)) and an output of the second speaker(s) (e.g., 1020 of FIG. 10B) (e.g., bottom speaker(s)). There is no limitation on a manner of controlling the at least one speaker 340a. As the at least one speaker 340a is controlled in operation 917, howling may be decreased.

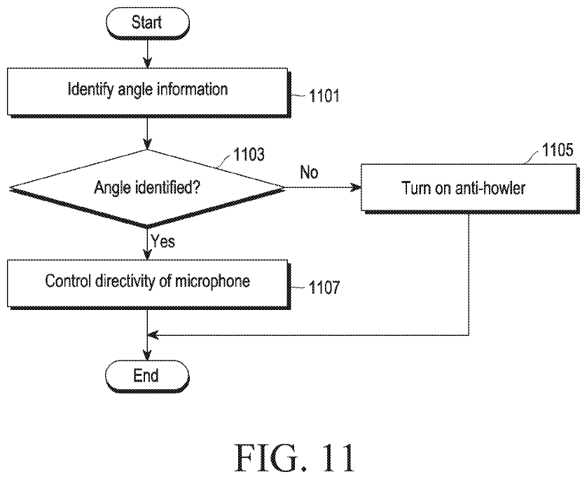

FIG. 11 is a flowchart illustrating an example method of operating the electronic device 101, according to an embodiment. FIG. 11 may be described with reference to FIGS. 10A, 10B, and the previously described examples.

With reference to FIGS. 11, 10A, and 10B, an operation of controlling a directivity of at least one microphone (e.g., 330a of FIG. 3) of the electronic device 101 based on an angle (or direction) of the external electronic device 104 with respect to the electronic device 101 may be described. The operation(s) of FIG. 11 may be performed simultaneously or sequentially with the operation(s) of FIG. 9. For example, the operation of controlling at least one speaker (e.g., 340a of FIG. 3) of the electronic device 101 of FIG. 9, and the operation of controlling at least one microphone (e.g., 330a of FIG. 3) of FIG. 11 may be performed simultaneously or sequentially.

At least a portion of the operations of FIG. 11 may be omitted. The operation order of the operations of FIG. 11 may be changed. Operations other than the operations of FIG. 11 may be performed before, while, or after performing the operations of FIG. 11.

Referring to FIG. 11, in operation 1101, according to an embodiment, the electronic device 101 (e.g., the processor 120) may identify angle information (or direction information) corresponding to the external electronic device 104, using the second communication circuit 320a supporting a UWB scheme. Operation 1101 may be a portion of operation 709 of FIG. 7. Operation 1101 may correspond to operation 901 of FIG. 9.

In operation 1103, according to an embodiment, the electronic device 101 (e.g., the processor 120) may perform operation 1105 based on the angle (or direction) of the external electronic device 104 with respect to the electronic device 101 not being identified based on the angle information, and may perform operation 1107 based on the angle (or direction) of the external electronic device 104 with respect to the electronic device 101 being identified.

In operation 1105, according to an embodiment, the electronic device 101 (e.g., the processor 120) may control the anti-howler (e.g., 620 of FIG. 6) to be on, based on the angle (or direction) of the external electronic device 104 with respect to the electronic device 101 not being identified. Operation 1105 may correspond to operation 905 of FIG. 9.

In operation 1107, according to an embodiment, the electronic device 101 (e.g., the processor 120) may control a directivity (or beamforming direction) of the at least one microphone (e.g., 330a of FIG. 3) of the electronic device 101, based on the angle (or direction) of the external electronic device 104 with respect to the electronic device 101. The electronic device 101 (e.g., the processor 120) may control the at least one microphone (e.g., 330a of FIG. 3), based on the angle, or direction) of the external electronic device 104 with respect to the electronic device 101, so that a directivity (or beamforming direction) of the at least one microphone (e.g., 330a of FIG. 3) of the electronic device 101 does not face the external electronic device 104. The electronic device 101 (e.g., the processor 120) may filter voice in a specific direction by controlling a delay and a directivity of the at least one microphone (e.g., 330a of FIG. 3). As the directivity (or beamforming direction) of the at least one microphone (e.g., 330a of FIG. 3) of the electronic device 101 is controlled, howling may be decreased.

Those skilled in the art may understand that the various example embodiments described in this disclosure may be applied in a mutually crossed manner within an applicable range. For example, it will be understood by one of ordinary skill in the art that at least some operations of an embodiment described in the disclosure may be omitted and applied, or at least some operations of an embodiment may be applied in connection with each other.

Effects obtainable from the disclosure are not limited to the above-mentioned effects, and other effects not mentioned may be clearly understood by those skilled in the art from the disclosure.

According to an example embodiment, an electronic device 101; 200 may include memory 130 storing instructions, a communication circuit 320a supporting an ultra wide band (UWB) scheme, at least one microphone 330a, at least one speaker 340a, and a processor 120. The instructions may be configured to, when executed by the processor 120, cause the electronic device 101; 200 to perform a call connection to a first external device 104; 210. The instructions may be configured to, when executed by the processor 120, cause the electronic device 101; 200 to identify a first token including information related to the call connection to the first external device 104; 210. The instructions may be configured to, when executed by the processor 120, cause the electronic device 101; 200 to transmit the first token and receive a second token, using the communication circuit 320a. The instructions may be configured to, when executed by the processor 120, cause the electronic device 101; 200 to identify information related to a call connection of an external device transmitting the second token, based on the second token. The instructions may be configured to, when executed by the processor 120, cause the electronic device 101; 200 to, based on the information related to the call connection included in the second token corresponding to the information related to the call connection to the first external device 104; 210, or information of the electronic device 101; 200, identify that the external device transmitting the second token is the first external device 104; 210. The instructions may be configured to, when executed by the processor 120, cause the electronic device 101; 200 to identify distance information and/or angle information between the first external device 104; 210 and the electronic device 101; 200, using the communication circuit 320a. The instructions may be configured to, when executed by the processor 120, cause the electronic device 101; 200 to control an anti-howler related to the call connection, based on the distance information and/or the angle information.

According to an example embodiment, the instructions may be configured to, when executed by the processor 120, cause the electronic device 101; 200 to, based on the information related to the call connection included in the second token not corresponding to the information related to the call connection to the first external device 104; 210, or the information of the electronic device 101; 200, control the anti-howler to be off.

According to an example embodiment, the instructions may be configured to, when executed by the processor 120, cause the electronic device 101; 200 to, based on a distance between the first external device 104; 210 and the electronic device 101; 200 being within a reference distance based on the distance information, decrease a reference value of the anti-howler.

According to an example embodiment, the instructions may be configured to, when executed by the processor 120, cause the electronic device 101; 200 to, based on the distance between the first external device 104; 210 and the electronic device 101; 200 being greater than the reference distance based on the distance information, increase the reference value of the anti-howler.

According to an example embodiment, the instructions may be configured to, when executed by the processor 120, cause the electronic device 101; 200 to, based on a distance between the first external device 104; 210 and the electronic device 101; 200 not being identified based on the distance information, control the anti-howler to be off.

According to an example embodiment, the instructions may be configured to, when executed by the processor 120, cause the electronic device 101; 200 to, based on an angle of the electronic device 101; 200 with respect to the first external device 104; 210 being included in a first reference range based on the angle information, decrease an output of a first speaker 340a corresponding to the first reference range among the at least one speaker 340a.

According to an example embodiment, the instructions may be configured to, when executed by the processor 120, cause the electronic device 101; 200 to, based on the angle of the electronic device 101; 200 with respect to the first external device 104; 210 being included in a second reference range based on the angle information, decrease an output of a second speaker 340a corresponding to the second reference range among the at least one speaker 340a.

According to an example embodiment, the instructions may be configured to, when executed by the processor 120, cause the electronic device 101; 200 to, based on the angle of the electronic device 101; 200 with respect to the first external device 104; 210 being included in a third reference range based on the angle information, control an output of the first speaker 340a and an output of the second speaker 340a.

According to an example embodiment, the instructions may be configured to, when executed by the processor 120, cause the electronic device 101; 200 to, based on an angle between the first external device 104; 210 and the electronic device 101; 200 not being identified based on the angle information, control the anti-howler to be on.

According to an example embodiment, the instructions may be configured to, when executed by the processor 120, cause the electronic device 101; 200 to control a directivity of the at least one microphone 330a based on an angle of the electronic device 101; 200 with respect to the first external device 104; 210 based on the angle information.

According to an example embodiment, a method of operating an electronic device 101; 200 may include performing a call connection to a first external device 104; 210. The method may include identifying a first token including information related to the call connection to the first external device 104; 210. The method may include transmitting the first token and receiving a second token, using a communication circuit 320a supporting an ultra wide band (UWB) scheme. The method may include identifying information related to a call connection of an external device transmitting the second token, based on the second token. The method may include, based on the information related to the call connection included in the second token corresponding to the information related to the call connection to the first external device 104; 210, or information of the electronic device 101; 200, identifying that the external device transmitting the second token is the first external device 104; 210. The method may include identifying distance information and/or angle information between the first external device 104; 210 and the electronic device 101; 200, using the communication circuit 320a. The method may include controlling an anti-howler related to the call connection, based on the distance information and/or the angle information.

According to an example embodiment, the method may include, based on the information related to the call connection included in the second token not corresponding to the information related to the call connection to the first external device 104; 210, or the information of the electronic device 101; 200, controlling the anti-howler to be off.

According to an example embodiment, controlling the anti-howler may include, based on a distance between the first external device 104; 210 and the electronic device 101; 200 being within a reference distance based on the distance information, decreasing a reference value of the anti-howler.

According to an example embodiment, controlling the anti-howler may include, based on the distance between the first external device 104; 210 and the electronic device 101; 200 being greater than the reference distance based on the distance information, increasing the reference value of the anti-howler.

According to an example embodiment, controlling the anti-howler may include, based on a distance between the first external device 104, 210 and the electronic device 101; 200 not being identified based on the distance information, controlling the anti-howler to be off.

According to an example embodiment, controlling the anti-howler may include, based on an angle of the electronic device 101; 200 with respect to the first external device 104; 210 being included in a first reference range based on the angle information, decreasing an output of a first speaker 340a corresponding to the first reference range among at least one speaker 340a of the electronic device 101; 200.

According to an example embodiment, controlling the anti-howler may include, based on the angle of the electronic device 101; 200 with respect to the first external device 104; 210 being included in a second reference range based on the angle information, decreasing an output of a second speaker 340a corresponding to the second reference range among the at least one speaker 340a.

According to an example embodiment, controlling the anti-howler may include, based on the angle of the electronic device 101; 200 with respect to the first external device 104; 210 being included in a third reference range based on the angle information, controlling an output of the first speaker 340a and an output of the second speaker 340a.

According to an example embodiment, controlling the anti-howler may include, based on an angle between the first external device 104; 210 and the electronic device 101; 200 not being identified based on the angle information, controlling the anti-howler to be on.

According to an example embodiment, controlling the anti-howler may include controlling a directivity of the at least one microphone 330a based on an angle of the electronic device 101; 200 with respect to the first external device 104; 210 based on the angle information.

According to an example embodiment, in a non-transitory computer-readable recording medium storing instructions configured to cause a processor 120 of an electronic device 101; 200 to perform at least one operation, the at least one operation may include performing a call connection to a first external device 104; 210. The at least one operation may include identifying a first token including information related to the call connection to the first external device 104; 210. The at least one operation may include transmitting the first token and receiving a second token, using a communication circuit 320a supporting an ultra wide band (UWB) scheme. The at least one operation may include identifying information related to a call connection of an external device transmitting the second token, based on the second token. The at least one operation may include, based on the information related to the call connection included in the second token corresponding to the information related to the call connection to the first external device 104; 210, or information of the electronic device 101; 200, identifying that the external device transmitting the second token is the first external device 104; 210. The at least one operation may include identifying distance information and/or angle information between the first external device 104; 210 and the electronic device 101; 200, using the communication circuit 320a. The at least one operation may include controlling an anti-howler related to the call connection, based on the distance information and/or the angle information.

According to an example embodiment, the at least one operation may include, based on the information related to the call connection included in the second token not corresponding to the information related to the call connection to the first external device 104; 210, or the information of the electronic device 101; 200, controlling the anti-howler to be off.

According to an example embodiment, controlling the anti-howler may include, based on a distance between the first external device 104; 210 and the electronic device 101; 200 being within a reference distance based on the distance information, decreasing a reference value of the anti-howler.

According to an example embodiment, controlling the anti-howler may include, based on the distance between the first external device 104; 210 and the electronic device 101; 200 being greater than the reference distance based on the distance information, increasing the reference value of the anti-howler.

According to an example embodiment, controlling the anti-howler may include, based on a distance between the first external device 104; 210 and the electronic device 101; 200 not being identified based on the distance information, controlling the anti-howler to be off.

According to an example embodiment, controlling the anti-howler may include, based on an angle of the electronic device 101; 200 with respect to the first external device 104; 210 being included in a first reference range based on the angle information, decreasing an output of a first speaker 340a corresponding to the first reference range among at least one speaker 340a of the electronic device 101; 200.

According to an example embodiment, controlling the anti-howler may include, based on the angle of the electronic device 101; 200 with respect to the first external device 104; 210 being included in a second reference range based on the angle information, decreasing an output of a second speaker 340a corresponding to the second reference range among the at least one speaker 340a.

According to an example embodiment, controlling the anti-howler may include, based on the angle of the electronic device 101; 200 with respect to the first external device 104; 210 being included in a third reference range based on the angle information, controlling an output of the first speaker 340a and an output of the second speaker 340a.

According to an example embodiment, controlling the anti-howler may include, based on an angle between the first external device 104; 210 and the electronic device 101; 200 not being identified based on the angle information, controlling the anti-howler to be on.

According to an example embodiment, controlling the anti-howler may include controlling a directivity of the at least one microphone 330a based on an angle of the electronic device 101; 200 with respect to the first external device 104; 210 based on the angle information.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium that is readable by a machine (e.g., an electronic device). For example, a processor (e.g., a controller) of the machine may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
memory storing instructions;
communication circuitry configured to support an ultra wide band (UWB) scheme;
at least one microphone;
at least one speaker; and
at least one processor, comprising processing circuitry,
wherein the instructions, when executed by at least one processor individually and/or collectively, cause the electronic device to:
perform a call connection with a first external device,
identify a first token including information related to the call connection with the first external device,
transmit the first token and receive a second token, using the communication circuitry
based on the second token, identify information related to a call connection of an external device that has transmitted the second token,
based on the information related to the call connection included in the second token corresponding to the information related to the call connection with the first external device or information of the electronic device, identify that the external device that has transmitted the second token is the first external device,
identify distance information and/or angle information between the first external device and the electronic device using the communication circuitry, and
based on the distance information and/or the angle information, control an anti-howler, comprising circuitry, configured to remove a howling component related to the call connection.

2. The electronic device of claim 1, wherein the instructions, when executed by at least one processor individually and/or collectively, cause the electronic device to:
based on the information related to the call connection included in the second token not corresponding to the information related to the call connection with the first external device or the information of the electronic device, control the anti-howler to be off.

3. The electronic device of claim 1, wherein the instructions, when executed by at least one processor individually and/or collectively, cause the electronic device to:
based on the distance information and based on a distance between the first external device and the electronic device being within a reference distance, decrease a reference value of the anti-howler.

4. The electronic device of claim 3, wherein the instructions, when executed by at least one processor individually and/or collectively, cause the electronic device to:
based on the distance information and based on the distance between the first external device and the electronic device being greater than the reference distance, increase the reference value of the anti-howler.

5. The electronic device of claim 1, wherein the instructions, when executed by at least one processor individually and/or collectively, cause the electronic device to:
based on the distance information and based on a distance between the first external device and the electronic device not being identified, control the anti-howler to be off.

6. The electronic device of claim 1, wherein the instructions, when executed by at least one processor individually and/or collectively, cause the electronic device to:
based on the angle information and based on an angle of the electronic device with respect to the first external device being included in a first reference range, decrease an output of a first speaker corresponding to the first reference range among the at least one speaker.

7. The electronic device of claim 6, wherein the instructions, when executed by at least one processor individually and/or collectively, cause the electronic device to:
based on the angle information and based on the angle of the electronic device with respect to the first external device being included in a second reference range, decrease an output of a second speaker corresponding to the second reference range among the at least one speaker.

8. The electronic device of claim 7, wherein the instructions, when executed by at least one processor individually and/or collectively, cause the electronic device to:
based on the angle information and based on the angle of the electronic device with respect to the first external device being included in a third reference range, control the output of the first speaker and the output of the second speaker.

9. The electronic device of claim 1, wherein the instructions, when executed by at least one processor individually and/or collectively, cause the electronic device to:
based on the angle information and based on an angle between the first external device and the electronic device not being identified, control the anti-howler to be on.

10. The electronic device of claim 1, wherein the instructions, when executed by at least one processor individually and/or collectively, cause the electronic device to:
based on the angle information and based on an angle of the electronic device with respect to the first external device, control a directivity of at least one microphone.

11. A method of operating an electronic device, the method comprising:
performing a call connection to a first external device;
identifying a first token including information related to the call connection to the first external device;
transmitting the first token and receiving a second token, using a communication circuit supporting an ultra wide band (UWB) scheme;
identifying information related to a call connection of an external device transmitting the second token, based on the second token;
based on the information related to the call connection included in the second token corresponding to the information related to the call connection to the first external device or information of the electronic device, identifying that the external device transmitting the second token is the first external device;
identifying distance information and/or angle information between the first external device and the electronic device, using the communication circuit; and
controlling an anti-howler related to the call connection, based on the distance information and/or the angle information.

12. The method of claim 11, comprising:
based on the information related to the call connection included in the second token not corresponding to the information related to the call connection to the first external device or the information of the electronic device, controlling the anti-howler to be off.

13. The method of claim 11, wherein controlling the anti-howler includes:
based on a distance between the first external device and the electronic device being within a reference distance based on the distance information, decreasing a reference value of the anti-howler.

14. A non-transitory computer-readable recording medium storing instructions which, when executed by at least one processor, comprising processing circuitry, of an electronic device individually and/or collectively, cause the electronic device to perform at least one operation, comprising:
performing a call connection to a first external device;
identifying a first token including information related to the call connection to the first external device;
transmitting the first token and receiving a second token, using a communication circuit supporting an ultra wide band (UWB) scheme;
identifying information related to a call connection of an external device transmitting the second token, based on the second token;
based on the information related to the call connection included in the second token corresponding to the information related to the call connection to the first external device or information of the electronic device, identifying that the external device transmitting the second token is the first external device;
identifying distance information and/or angle information between the first external device and the electronic device, using the communication circuit; and
controlling an anti-howler related to the call connection, based on the distance information and/or the angle information.

15. The non-transitory computer-readable recording medium of claim 14, wherein the at least one operation includes, based on the information related to the call connection included in the second token not corresponding to the information related to the call connection to the first external device or the information of the electronic device, controlling the anti-howler to be off.

16. The non-transitory computer-readable recording medium of claim 14, wherein the at least one operation includes:
based on the distance information and based on a distance between the first external device and the electronic device being within a reference distance, decreasing a reference value of the anti-howler.

17. The non-transitory computer-readable recording medium of claim 16, wherein the at least one operation includes:
based on the distance information and based on the distance between the first external device and the electronic device being greater than the reference distance, increasing the reference value of the anti-howler.

18. The non-transitory computer-readable recording medium of claim 14, wherein the at least one operation includes:
based on the distance information and based on a distance between the first external device and the electronic device not being identified, controlling the anti-howler to be off.

19. The non-transitory computer-readable recording medium of claim 14, wherein the at least one operation includes:
based on the angle information and based on an angle of the electronic device with respect to the first external device being included in a first reference range, decreasing an output of a first speaker corresponding to the first reference range among the at least one speaker.

20. The non-transitory computer-readable recording medium of claim 19, wherein the at least one operation includes:
based on the angle information and based on the angle of the electronic device with respect to the first external device being included in a second reference range, decreasing an output of a second speaker corresponding to the second reference range among the at least one speaker.
